(19) United States
(12) Patent Application Publication
(10) Pub. No.: US 2026/0177953 A1
(43) Pub. Date: Jun. 25, 2026

(54) IMAGE FORMING APPARATUS

(71) Applicant: CANON KABUSHIKI KAISHA, Tokyo (JP)

(72) Inventors: ASUNA FUKAMACHI, Chiba (JP); TAKAHIRO OHNISHI, Chiba (JP); KENGO KOYAMA, Chiba (JP)

(21) Appl. No.: 19/393,744

(22) Filed: Nov. 19, 2025

(30) Foreign Application Priority Data
Dec. 20, 2024 (JP) 2024-225115

(51) Int. Cl. G03G 15/20; G03G 15/00; G06K 15/00; G06K 15/12

(52) U.S. Cl. CPC G03G 15/205; G03G 15/2025; G03G 15/2064; G03G 15/5016; G03G 15/5029; G06K 15/005; G06K 15/128; G06K 15/4065; G06K 15/4075; G03G 2215/00734; G03G 2215/2035

(57) ABSTRACT

Disclosed is an image forming apparatus including: an image forming portion to form a toner image on a sheet; a fixing portion to fix the toner image formed on the sheet at a nip portion formed between a fixing member and a pressure member; a cleaning portion to collect toner attached to the fixing member; a controller to control the fixing member such that the fixing member operates at a set adjusted temperature; and a display control portion to display a screen at a display portion, wherein when the controller performs an operation mode in which the controller controls the fixing member such that the fixing member operates at an adjusted temperature higher than a preset temperature, the display control portion performs a warning process to urge a cleaning operation that cleans the nip portion using a sheet passing through the nip portion based on print information of a print without margin performed before the operation mode, a toner image being formed until at least one end portion in the print without margin.

### BACKGROUND

### Field of the Technology

This disclosure relates to an image forming apparatus that forms a toner image on a sheet.

### Description of the Related Art

In an image forming apparatuses using electrophotographic system, it is required not only to produce a printed product with margins in which an image is formed on a sheet with margins on edges of the sheet but also to produce a printed product without margins in which an image is formed on the entire sheet without margins. In a printed product without margins, a margin is not provided on at least a part of an edge portion and in order to produce a printed product without margins, it is required to form an image larger than a sheet and to transfer the image on the sheet.

However, when an image whose size is larger than a sheet is formed and transferred on the sheet, toner is attached to edges of the sheet (narrow edges of the sheet in the thickness direction). The toner attached to the edges of the sheet is not fixed enough to the sheet even after it has passed through the nip portion of the fixing device, causing the toner to be attached to portions other than the sheet to lead toner smear.

The Japanese Patent Application Laid-open No. 2010-139881 proposes the configuration in which a cleaning member is provided that can be abutted against and separated from a fixing member that forms a nip portion in a fixing device and toner attached to the fixing member is collected by the cleaning member.

### SUMMARY

One aspect of the present disclosure is an image forming apparatus comprising:
an image forming portion configured to form a toner image on a sheet;
a fixing portion configured to fix the toner image formed on the sheet at a nip portion formed between a fixing member and a pressure member;
a cleaning portion configured to collect toner attached to the fixing member;
a controller configured to control the fixing member such that the fixing member operates at a set adjusted temperature; and
a display control portion configured to display a screen at a display portion,
wherein when the controller performs an operation mode in which the controller controls the fixing member such that the fixing member operates at an adjusted temperature higher than a preset temperature, the display control portion performs a warning process to urge a cleaning operation that cleans the nip portion using a sheet passing through the nip portion based on print information of a print without margin performed before the operation mode, a toner image being formed until at least one end portion in the print without margin.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram showing a cross-sectional view of an image forming apparatus.

FIG. 2 is a control block diagram of the image forming apparatus.

FIG. 3 is a diagram showing a configuration of the fixing device.

FIG. 4 is a graph showing the toner melting viscosity property.

FIG. 5 is a flowchart showing the operation of the first embodiment.

FIG. 6 is a diagram showing one example of a warning screen of an operation panel portion.

FIG. 7 is a diagram showing one example of a processing screen of the operation panel portion.

FIG. 8 is a flowchart showing the operation of the second embodiment.

FIG. 9 is a flowchart showing the operation of the third embodiment.

FIG. 10 is a diagram showing a printed product with margins and printed products without a margin.

FIG. 11 is a diagram showing a table of examples of calculation coefficients of offset toner amount in sheet information.

### DESCRIPTION OF THE EMBODIMENTS

Hereinafter, with reference to the drawings, embodiments of the present disclosure will be exemplarily described in detail. The sizes, materials, shapes and relative arrangement of the components described in the following are just examples and not intended to limit to only ones in the following embodiments.

### First Embodiment

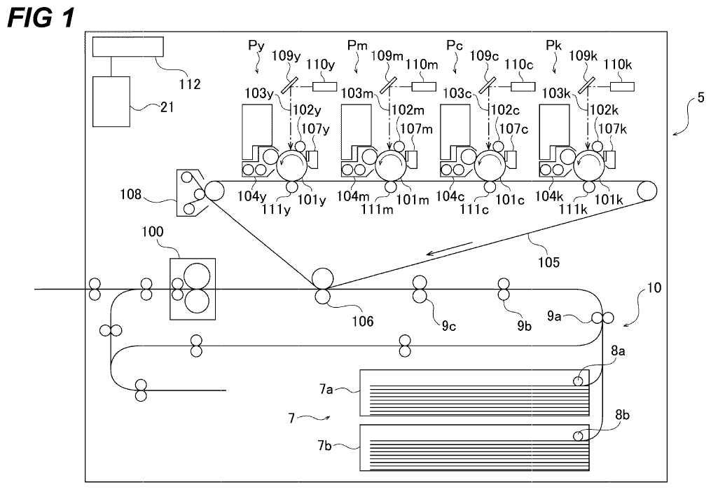

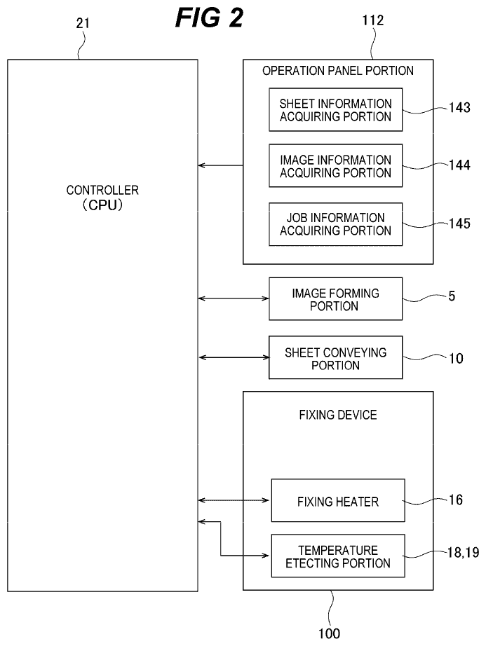

The image forming apparatus and the control of a fixing temperature according to the first embodiment will be described with reference to FIGS. 1 and 2. FIG. 1 is a diagram showing a cross-sectional view of the image forming apparatus. FIG. 2 is a control block diagram for the image forming apparatus according to the first embodiment. In the present embodiment, the image forming apparatus for forming an image using the electrophotographic system is exemplified.

### (Image Forming Apparatus)

Inside the image forming apparatus, the sheet feeding mechanism 7, the image forming portion 5, and the fixing device 100 are disposed in this order from the upstream side to the downstream side along a sheet conveying path.

As shown in FIG. 2, in the image forming apparatus, provided are the controller 21 represented by for example a CPU, and the operation panel portion 112 serving as an interface for accessing and communicating with a user or an external device.

The operation panel portion 112 functions as an interface for a user to access the apparatus. The controller 21 watches and controls the states of the portions such as the image forming portion 5, the sheet feeding mechanism 7, the sheet conveying portion 10 and the fixing device 100 while supervising a chain of commands between the portions of the apparatus so that the image forming apparatus operates properly.

The operation panel portion 112 has the sheet information acquiring portion 143, the image information acquiring portion 144 and the job information acquiring portion 145. The sheet information acquiring portion 143 acquires the sheet information such as basis weight, surface properties, size as print job information, which is input by a user. The image information acquiring portion 144 acquires basic setting information of image information such as density. The job information acquiring portion 145 acquires job information such as a number of printed sheets in a job, duplex/simplex information, “no margin mode” in which an image is formed on an entire sheet without providing margins on edge portions, and “high gloss mode”.

A job in the present embodiment means print information (data) regarding a print converted in an executable form by the controller 21. The job includes not only print instructions and print data for the controller 21 but also information regarding a number of sheets to be printed and types of sheets.

In the present embodiment, the operation panel portion 112 is exemplified by an operation panel portion of touch panel type. The operation panel portion 112 of touch panel type includes an operation surface in which input portions like touch pads are disposed in a multilayered manner on a screen of a display portion like liquid crystal. By pushing the display image on the operation surface, instructions for operating the image forming apparatus can be detected (input).

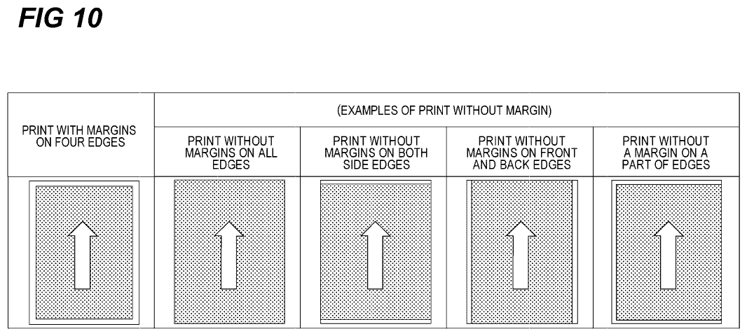

Next, one example of print without margins will be described with reference to FIG. 10. The image forming apparatus according to the present embodiment can perform print with margins and print without margins. Based on job information, the image forming apparatus cheeses one between print with margins and print without margins. In this embodiment, the print with margins means making a print product with margins on four edge portions and the print without margins means a printed product a margin is not provided at least one edge of a sheet. The print without margins has multiple variations. For example, the variations include print without margins on all edge portions and an image is formed to cover all the edge portions. The variations further include print without margins on short edges and an image is formed to cover all the long edge portions. The variations further include print without margins on long edges and an image is formed to cover all the short edge portions. The variations further include print without margins on a part of the edge portions and an image is formed to cover all the other part of the edge portions. The variations further include print without margins on one of the edge portions and an image is formed to cover all the other three edge portions.

A high gloss mode is a print mode in which a product with high glossiness is output by smoothing a toner image surface formed on a sheet. In the high gloss mode, which is a high temperature operating mode, an adjusted temperature of the fixing device is set to be higher than a predetermined temperature. In the high gloss mode, an adjusted temperature of the fixing device is set to be higher than a predetermined temperature such as a toner remelting temperature.

### (Image Forming Portion)

The image forming portion 5 (Py, Pm, Pc and Pk) includes the image forming portion Py for yellow, the image forming portion Pm for magenta, the image forming portion Pc for cyan and the image forming portion Pk for black.

Each image forming portion 5 (Py, Pm, Pc and Pk) includes the photosensitive drum 101 as a image bearing member, the charging device 102 as a process device that affects the photosensitive drum 101, the developing device 104 and the drum cleaner 107 and so on.

The photosensitive drum 101 is driven to rotate in a counterclockwise direction in FIG. 1 at a predetermined process speed (circumferential speed). The photosensitive drum 101 is charged at a predetermined polarity by the charging device 102 such as a charging roller during rotation.

An exposure process is performed on the charging processing surface of the photosensitive drum 101 by the laser beam 103 output from the laser optical system 110 as an exposure portion based on input image information. The laser optical system 110 outputs the laser beam 103 modulated (turned on and off) according to time-sequence electric digital pixel signal of the target image information from an image signal generating device such as an image reading apparatus (not shown), and performs a scanning exposure for the photosensitive drum 101. As a result, an electrostatic latent image corresponding to the image information is formed on the photosensitive drum 101 by this scanning exposure. The mirror 109 deflects the laser beam 103 from the laser optical system 110 to an exposure position of the photosensitive drum 101.

The electrostatic latent image formed on the photosensitive drum is visualized with toner by the developing device 104. This toner image is transferred to the intermediate transfer belt 105 by the primary transfer roller 111 at a primary transfer portion as a contact portion between the photosensitive drum 101 and the intermediate transfer belt 105. As stated before, the toner image of each color formed on each photosensitive drum 101 of each image forming portion is transferred to the intermediate transfer belt 105 in a superimposed manner by each primary transfer roller 111 at each primary transfer portion. Remaining toner on each photosensitive drum 101 after transfer is cleaned by each drum cleaner 107.

In case of a print with margins, a sheet on which an image is formed with margins at edge portions of the sheet is produced by forming an electrostatic latent image with a range narrower than that of the sheet on the photosensitive drum 101. In case of a print without margins, a sheet on the entire surface of which an image is formed without margins at edge portions of the sheet is produced by forming an electrostatic latent image wider than the sheet on the photosensitive drum 101.

When a print job information is input to the controller (CPU) 21 from the operation panel portion 112 and an image forming process is instructed, the feeding roller 8a of the sheet cassette 7a or the feeding roller 8b of the sheet cassette 7b, which respectively accommodate sheets of a designated size is driven. As a result, the sheets P from the sheet cassette 7a or the sheet cassette 7b are separated one by one and are introduced to a second transfer portion of the image forming portion 5 through the sheet conveying portion 10 including the conveying rollers 9a, 9b and 9c.

The toner image with multiple colors transferred in a sequentially superimposed manner onto the intermediate transfer belt 105 from the photosensitive drums 101 is secondarily transferred onto the sheet introduced to the secondary transfer portion in a batch by the secondary transfer roller 106. The toner remaining on the intermediate transfer belt 105 after transfer is cleaned by the intermediate transfer member cleaner 108.

The sheet having passed through the secondary transfer roller 106 is introduced to the nip portion of the fixing device 100 as an image heating device where an unfixed toner image on the sheet is fixed (heated). The sheet on which the image is fixed is discharged outside the apparatus and the series of image forming operations are ended.

### (Fixing Device)

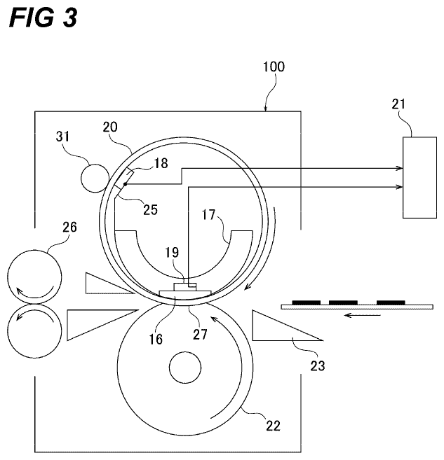

The fixing device 100 will be described with reference to FIG. 3. FIG. 3 is a diagram showing a cross-section of the fixing device 100.

The fixing device 100 includes a fixing unit as a fixing member and the pressure roller 22 as a pressure member.

The fixing unit is disposed at the upper side to the pressure roller 22 and is provided with the fixing heater 16, the heater holder 17 and the fixing belt 20. The fixing unit is disposed in parallel with the pressure roller 22 such that the fixing heater 16 side of the fixing unit is in contact with the pressure roller 22.

The fixing belt 20 is a cylindrical endless belt with an elastic layer. The pressure roller 22 is a pressure member that forms the fixing nip portion 27 between the fixing belt 20 and the pressure roller 22. The heater holder 17 has heat-resistant property and a gutter-like shape in a cross-section. The fixing heater 16 as a heating member is secured to the lower surface of the heater holder 17 along the longitudinal direction by adhesive. The fixing heater 16 is configured to be able to slide with the fixing belt 20. The fixing belt 20 is outwardly fitted to the circumference of the heater holder 17.

The fixing belt 20 is provided with a cylindrical base material formed as a cylindrical stainless steel with a thickness of about 30 [μm], the silicone rubber layer (elastic layer) with a thickness of about 300 [μm] formed on the cylindrical base material, the PFA resin tube (uppermost surface layer) with a thickness of about 30 [μm] coated on a surface layer).

The pressure roller 22 has the core metal made of Fe, a silicone rubber layer with a thickness of about 2.5 [mm] and a PFA resin tube with a thickness of about 50 [μm] are layered on the surface of the core metal. Both end portions of the core metal of the pressure roller 22 are rotatably held between the both side plates of the fixing device 100.

The heater holder 17 is formed by liquid crystal polymer resin with high heat resistance. The heater holder 17 holds the fixing heater 16 and plays a role for guiding the circulation of the fixing belt 20. Both end portions of the heater holder 17 are urged in the axial direction of the pressure roller 22 with 157 [N] par one end portions, namely, with 314 [N] for total of two end portions by a pressure mechanism (not shown). As a result, the surface of the fixing heater 16 is pressed to the elastic layer of the pressure roller 22 via the fixing belt 20 with a predetermined pressing force so that the nip portion 27 with a predetermined width necessary for fixing is formed.

The fixing heater 16 includes a ceramic board made from alumina or aluminum nitride and a resistor heating member which is evenly formed into a film with a thickness of about 10 [μm] on the ceramic board by applying conductive paste including silver/palladium alloy using screen printing method. A glass coating is formed on the heating member to ensure pressure-resistance.

The thermistor 19 as a temperature detecting portion is disposed along the width direction perpendicular to the conveying direction of the belt at around a center portion through which sheets in all sizes pass. The thermistor 19 detects a temperature of the fixing heater 16. The thermistor 19 sends the detected temperature to the controller 21. The controller 21 controls the electric power supplied to the fixing heater 16 such that the detected temperature is equal to the target temperature. This target temperature is set as the adjusted temperature of the fixing device 100 (fixing belt 20). Namely, the controller 21 performs such a control that the fixing belt 20 works at the set adjusted temperature (target temperature).

The fixing device 100 is disposed in the inner side of the fixing belt 20. The fixing device 100 is provided with the thermistor 18 as a temperature detecting portion that detects a temperature of the fixing belt 20 and the arm 25 that supports the thermistor 18. The thermistor 18 sends the detected temperature to the controller 21. The fixing device 100 is provided with the entrance guide 23 that guides a sheet to the fixing nip portion 27 and the fixing discharge roller 26 that conveys a sheet having passed through the fixing nip portion 27.

### (Cleaning Portion)

The fixing device 100 has the cleaning roller 31 as a cleaning portion that removes toner (offset toner) transferred to the fixing belt 20. The cleaning roller 31 collects toner (offset toner) attached to the fixing belt 20 by being driven to rotate while being in contact with the circumferential surface of the fixing belt 20.

The cleaning roller 31 is exemplified as a cleaning portion that collects toner (offset toner) attached to the fixing belt 20. However, the cleaning portion is not limited to the cleaning roller 31. It is preferable that the cleaning roller 31 is made from material that has high attachability with toner and whose surface is hard to damage the surface of the fixing belt 20 in view of a function of collecting offset toner. In the present embodiment, a silicone rubber roller is use as the cleaning roller 31. However, the cleaning roller 31 is not limited to a silicone rubber roller. A rotating member made of metal or an aramid fiber roller may abut against the fixing belt 20. Further, the second cleaning roller may be provided that is configured to abut against the cleaning roller 31 to collect toner on the cleaning roller 31. The timing of cleaning operation of the cleaning roller 31 for the fixing belt 20 can be controlled by controlling the abutment of the cleaning roller 31 to the fixing belt 20. The cleaning operation of the cleaning roller 31 for the fixing belt 20 is performed at least during the time period in which a sheet passes through the fixing nip portion.

### (Print Job of Margin-Less Print Mode)

In case of a job with a lot of sheets to be printed without margins, toner attached to a edge (narrow edge in the thickness direction of a sheet) of a sheet having passed through the fixing nip portion is collected by the cleaning roller 31 and accumulated on the surface of the cleaning roller 31.

When a job in which the adjusted temperature T of the fixing belt 20 becomes the adjusted temperature Tt that is higher than the toner remelting temperature Tn of the fixing belt 20 is issued with the offset toner being accumulated on the surface of the cleaning roller 31, the offset toner is remelted to be transferred again to the fixing belt 20.

Specifically, when the print accumulation sheet number (accumulation count sheet number) N of the print without margins exceeds the threshold value Nt (which corresponds to, for example, 500 sheets of A4 size, namely, a length of 210 [mm] in the sheet passing conveying direction), and when the adjusted temperature Tt of the fixing belt 20 is higher than the toner remelting temperature Tn of the offset toner, the offset toner remelts and is transferred to the fixing belt 20 again.

In the present embodiment, as the adjusted temperature (first adjusted temperature) of the normal printing mode (first operating mode), 130 to 150° C. is set. As the adjusted temperature (second adjusted temperature) Tt higher than the first adjusted temperature of the high gloss mode that is a high temperature operating mode (second operating mode), 165° C. is set. In the high gloss mode, the adjusted temperature (second adjusted temperature) Tt higher is higher than the toner remelting temperature Tn, so that the offset toner melts and is transferred to the fixing belt 20 again. When the high gloss mode is designated, a user may use a high grade sheet such as a super glossy sheet to produce a high gloss image. In this case, the toner having been transferred to the fixing belt 20, may be attached to such a sheet.

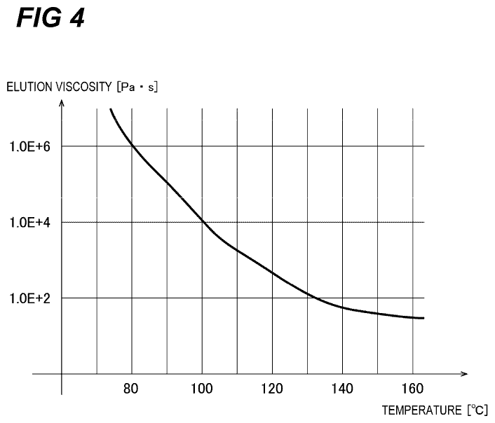

The toner remelting temperature Tn is a temperature at which the toner viscosity n becomes less than or equal to 50 [Pa·s](η0) and can be set by the measurement and verification described blow. FIG. 4 is a graph showing the toner melting viscosity property in which toner is measured by a flow tester according to the present embodiment. In FIG. 4, the horizontal axis indicates temperature (° C.) and the vertical axis indicates the melting viscosity. The toner melting viscosity is measured using the flow tester CFT-500D (Shimadzu Corporation) following the operational manual of this apparatus on the following conditions. In the present embodiment, polyester-type resin is used as color toner binder. Color toner is produced by a pulverizing method. Components of toner and producing method of the toner are not limited to the above. The suspension polymerization method, the interfacial polymerization method, the dispersion polymerization method and polymerization method can be used for producing toner.

Sample: sample is made by weighing 1.0 [g] of toner, molding the toner by a pressure molder with a diameter of 1 [cm] under pressure of a weight of 20 [kg] for one minute.
die hole diameter: 0.5 [mm] (higher than or equal to 130 [° C.]) 1.0 [mm] (lower than 130 [° C.]).
die length: 1.0 [mm].
cylinder pressure: 9.807×105 [Pa].
measurement mode: temperature rising method, temperature rising speed: 10 [° C./min] (higher than or equal to 130 [° C.]) 4.0 [° C./min] (lower than 130 [° C.]).

Using the above method, the viscosity [Pa·s] of the toner in the range from 50 to 200 [° C.] is measured. As understood from FIG. 4, when the temperature becomes higher, the melting viscosity of the toner becomes lower, so that the toner becomes easier to deform. Also understood from FIG. 4, the temperature at which the melting viscosity is less than about 50 [Pa·s] is higher than or equal to 160 [° C.]. Therefore, in the present embodiment, the toner remelting temperature Tn previously is set to 160 [° C.]. The previously set temperature (toner remelting temperature Tn) is just an example and the temperature is not limited to the above value and is set appropriately.

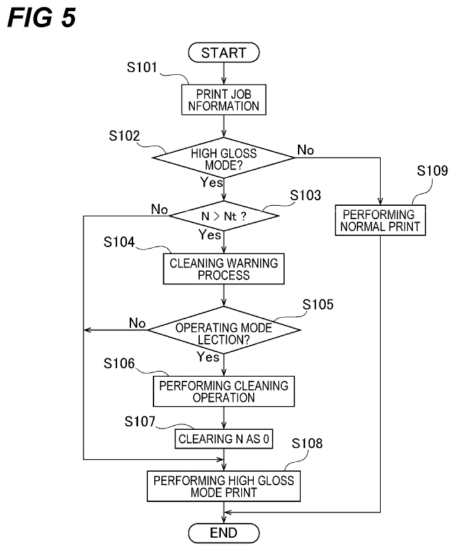

Therefore, in the present embodiment, in a print job of image forming flow shown by FIG. 5, when the print accumulation sheet number (accumulation count sheet number) N of in the mode of print without margins exceeds the threshold value Nt of 500 and when a job in which high gloss mode is designated is issued, a warning process that urges a user to perform a sheet passing cleaning operation, which will be described bellow.

Namely, before performing the high gloss mode, the controller 21 performs a warning process that urges to perform the cleaning operation that cleans the fixing nip portion 27 based on the print information of the print without margins performed before the high gloss mode.

In the present embodiment, the setting is made to have the history of passing 600 sheets with A4 size of OK topcoat+128 gsm (Oji Holdings Corporation).

In the present embodiment, in the print job of image forming flow shown by FIG. 5, the setting is made to have the history of passing 20 sheets with A3 size of OK topcoat+157 gsm (Oji Holdings Corporation) with the high gloss mode being designated.

### (Image Forming Flow)

Next, a print job of the image forming flow in the present embodiment will be described. FIG. 5 is a flowchart of the sheet passing cleaning operation warning mode in the present embodiment.

In the present embodiment, as the cleaning operation for cleaning the fixing nip portion 27, the sheet passing cleaning operation in which a cleaning sheet passes through the fixing nip portion 27 to collect offset toner is exemplified.

First, in step S101, the controller 21 acquires the print job information issued from the operation panel portion 112. In the present embodiment, the case is exemplified in which the print job information is acquired from the operation panel portion 112. However, the present disclosure is not limited to this configuration and the print job information may be acquired from an external device.

In step S102, the controller 21 judges whether the high gloss mode is designated or not based on the job information acquired in the step S101. Namely, the controller 21 judges whether the high gloss mode (high temperature operation mode) that controls the fixing belt 20 to operate at an adjusted temperature higher than the toner remelting temperature which has been previously set is designated. When the high gloss mode is designated, the sequence proceeds to the step S103 and otherwise the sequence proceeds to the step S109.

In the step S103, the controller 21 judges whether the print accumulation sheet number of print without margins (accumulation sheet number counter) N exceeds the threshold value Nt of 500 and whether it is necessary to issue a warning to urge the sheet passing cleaning operation. When the print accumulation sheet number N exceeds the threshold value Nt, the sequence proceeds to step S104 and otherwise the sequence proceeds to step S108.

Like this way, when the print accumulation sheet number N of the print performed before the high gloss mode exceeds the threshold value Nt, the controller 21 performs a warning process urging the sheet passing cleaning operation before the high gloss mode is started using the print accumulation sheet number as print information of print without margins.

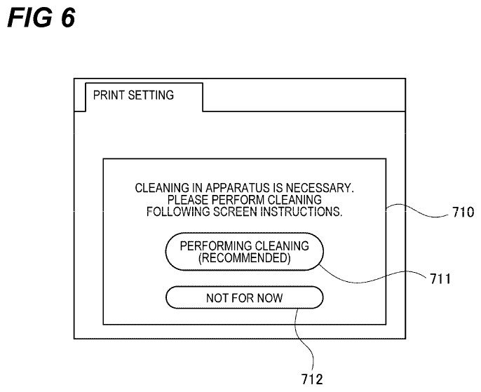

In the step S104, the controller 21 performs a warning process to urge the sheet passing cleaning operation. For example, as shown in FIG. 6, the warning screen 710 (or, the sheet passing cleaning execution selection screen) to urge the sheet passing cleaning operation to clean the cleaning roller 31 is displayed on the display portion of the operation pane portion 112.

FIG. 6 is an explanatory diagram indicating an example of a warning process according to the present embodiment. In the present embodiment, in step S104, as shown in FIG. 6, the controller 21 displays the warning screen 710 including the first operational key 711 for designating the cleaning operation and the second operational key 712 for not designating the cleaning operation on the display portion of the operation panel portion 112. In the warning screen 710 shown in FIG. 6, the key of “perform cleaning” is exemplified as the first operational key 711 and the key of “not for now” is exemplified as the second operational key 712.

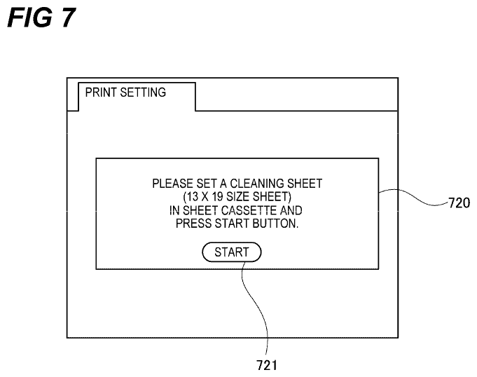

In the step S105, the controller 21 judges whether the sheet passing cleaning operation is performed or not based on the user selection information input from the operation panel portion 112. Namely, when the first operational key 711 is selected in the warning screen 710 displayed on the display portion of the operation panel portion 112 shown in FIG. 6, the controller 21 displays the sheet passing cleaning operation processing screen 720 shown in FIG. 7. On the other hand, when the second operational key 712 is selected, the controller 21 closes the warning screen 710 without performing the sheet passing cleaning operation and the sequence proceeds to the step S108.

FIG. 7 is an explanatory diagram showing an example of the sheet passing cleaning operation processing according to the present embodiment. As shown in FIG. 7, the controller 21 displays the processing screen 720 on the display portion of the operation panel portion 112. The processing screen 720 includes the operational key 721 for starting the cleaning operation. In the processing screen 720, the setting of a sheet to be used for the sheet passing cleaning operation is urged.

In the processing screen 720 shown in FIG. 7, “Start” key is exemplified as the operational key 721. When the operational key 721 is pushed, the sequence proceeds to the step S106.

In the step S106, the controller 21 performs the sheet passing cleaning operation. The sheet passing cleaning operation will be described later in detail.

In the step S107, the controller 21 clears the print accumulation sheet number of the print without margins (accumulation sheet number counter) N.

In the step S108, the controller 21 performs the print process in the high gloss mode which is a high temperature operation mode.

In the step S109, the controller 21 performs the print process in the normal print mode which is a normal operation mode.

Next, the sheet passing cleaning operation will be described. In the step S106, when the instruction for performing the sheet passing cleaning operation is input to the controller 21, the first cleaning sheet is fed from the sheet feeding mechanism 7. In the present embodiment, a sheet with a width of 13 [inch] is used as a cleaning sheet. The type and a number of cleaning sheets are not limited to the above as long as offset toner in the apparatus can be removed. When a plurality of sheet cassettes 7a and 7b accommodating sheets are provided in the image forming apparatus as shown in FIG. 1, a user may select one of these or one of these may be automatically selected based on priority.

The fed cleaning sheet is introduced to the fixing device 100 through the sheet conveying portion 10 with a toner image not being formed on both sides of the cleaning sheet. By the cleaning sheet with the maximum width passing through the fixing nip portion, offset toner remaining on the surface of the fixing belt 20 is transferred to the cleaning sheet, so that the offset toner can be removed.

In the present embodiment, the cleaning sheet is used without forming a toner image. However, a toner image can be formed when the cleaning property is improved. Further, offset toner is removed by the sheet passing cleaning operation. However, offset toner can be removed by a toner removing method other than the sheet passing cleaning operation.

In the present embodiment, a job using a high gloss mode is exemplified as an operating mode in which the adjusted temperature T of the fixing device becomes the adjusted temperature Tt that is higher than the toner remelting temperature Tn. However, the disclosure is not limited to this. When there exists an operation mode in which the adjusted temperature Tt is higher than the toner remelting temperature Tn, a similar warning process to urge the sheet passing cleaning operation is performed.

As described above, in the present embodiment, even when a job is issued in which the adjusted temperature of the fixing device 100 becomes the adjusted temperature Tt that is higher than the toner remelting temperature Tn, the accumulated toner can be appropriately removed by informing a user of it before the smear by toner retransfer to a sheet becomes tangible in the state where there exits a history of a job of a print without margins in which a lot of toner is accumulated on the cleaning roller 31. Namely, by performing a warning process to urge a cleaning operation for cleaning the fixing nip portion based on the print information of print without margins performed before the high gloss mode, the smear by toner retransfer to a sheet can be suppressed from becoming tangible.

### Second Embodiment

Next, an image forming apparatus according to the second embodiment will be described. The overall configurations of the image forming apparatus and the fixing device, a warning process, and a cleaning operation to clean a fixing nip portion are similar to those shown in FIGS. 1, 2, 6, and 7 in the first embodiment. Therefore, the same reference characters are attached to the members having the similar functions as those of the first embodiment and duplicate description will be omitted.

In the first embodiment, the print accumulation sheet number is used as print information of print without margins and when the accumulation count sheet number of a print without margins exceeds the threshold value, a warning screen urging a cleaning operation is displayed. However, the present disclosure is not limited to this. Depending on surface properties, basis weight, size information and image information of a sheet as print information, an amount of accumulated offset toner on the cleaning roller 31 changes. Therefore, in the present embodiment, previously supposed offset toner amount X at edge portions for a unit length in the width direction orthogonal to the sheet conveying direction according to the surface properties, basis weight, size information, and image information of a sheet is calculated, whereby a warning screen urging a cleaning operation is displayed and performed at a more appropriate timing.

Next, the amount of toner of a toner image formed on a sheet will be described. The image data input to the image forming portion is represented by 0 to 255 steps of 600 [dpi] data broken down into the C, M, Y and K colors from an image of a document. The data amount per one pixel is called image data amount. The maximum image data amount for each color is represented by 100 [%]. In response to the image data amount 0 to 100 [%], a toner amount to be used for image forming is calculated. The toner amount is amount of toner per a pixel of an image formed on a sheet. Toner amount is also represented by 0 to 100 [%], likewise the image data amount. The total toner weight of a toner image formed in the area range of 1 [cm²] is referred to as toner laid-on level [mg/cm²]. 100 [%] of toner amount per a single color means the maximum toner laid-on level of the color and of the maximum density. In the present embodiment, the maximum toner laid-on level of each color is set to 0.4 [mg/cm²]. Further, when total of respective colors exceeds 250 [%], the toner amount of respective colors is converted into the value less than or equal to 250 [%] by adjusting the toner amount for respective colors. Therefore, the maximum toner laid-on level of total of toner for respective colors is 1.0 [mg/cm²].

In the present embodiment, the maximum toner laid-on level Cmax [mg/mm] per a unit length in the width direction formed on edge portions of a sheet is calculated based on the image data amount distribution information, the sheet information, and job information. The toner amount at edge portions of a sheet means a toner amount in the image data region corresponding to the area from a sheet end position ±5 [mm] in the width direction orthogonal to the sheet conveying direction. In the present embodiment, the area from a sheet end position ±5 [mm] is set in view of registration precision position of the image forming apparatus being used. Specifically, the amount of toner in each divided width×10 areas×2 places at both ends, divided in 1 mm units in the width direction perpendicular to the sheet conveying direction, is obtained and the maximum value is set as Cmax. Let L be the accumulated length of conveying a sheet in a job of print without margins from the state where offset toner is not attached to the cleaning roller. Let A be a calculation coefficient of offset toner in each sheet information, the offset toner amount X is calculated by the following equation 1.

$$X = A \times {\sum }_{i = 0}^{L} Cmax \qquad ( Equation 1 )$$

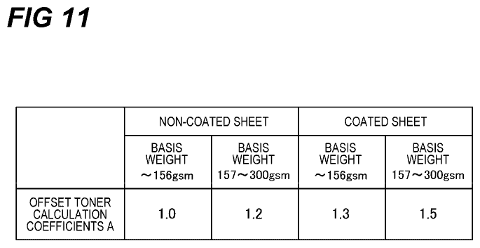

FIG. 11 shows the calculation coefficients A in respective sheet information (basis weights).

As shown in FIG. 11, when the roughness of the surface of a sheet is lower, namely, when the glossiness of a sheet is higher, the calculation coefficient A becomes higher. This is because when the roughness of the surface of a sheet is lower, namely, when the glossiness of a sheet is higher, an amount of toner used for image formation becomes larger and an offset toner amount becomes larger. When print without margins is performed, an offset toner amount increases in the vicinity of edges of a sheet for the same reason.

Further, when the basis weight of a sheet is greater, the calculation coefficient A becomes larger. This is because when the basis weight of a sheet is greater, the heat capacity of a sheet itself is higher and heat is more difficult to be transmitted during fixing process, so that an offset toner amount increases. When print without margins is performed, an edge area of a sheet that is a thickness of a sheet increases and an offset toner amount in the vicinity of edge portions increases.

In the present embodiment, the setting is made to have history of 100 sheets with A3 size of OK topcoat+128 gsm (Oji Holdings Corporation) passing through. Further, in this job of print without margins, the image information is set that uses a image data amount of 250 [%] in the entire area of a sheet, namely, a toner amount of 1.0 [mg/cm²]. In this setting, Cmax has the maximum value in a width division area corresponding to a side edge portion.

Since the length of a sheet with A3 size in the conveying direction is 420 [mm] and the calculation coefficient A is 1.3 as shown in FIG. 11, the offset toner amount X in the print job is calculated out as 819 by the equation 1.

Further, in a print job in the image forming flow described below in the present embodiment, the setting is made in which a high gloss mode is designated and 20 sheets with A3 size of OK topcoat+157 gsm (Oji Holdings Corporation) pass through.

### (Image Forming Flow)

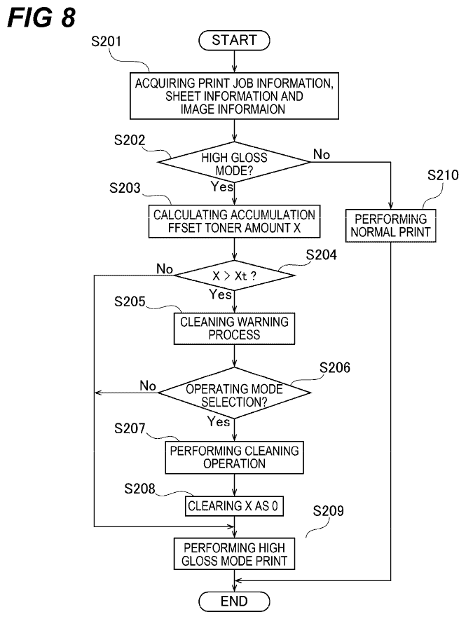

Next, a print job of an image forming flow in the present embodiment will be described. FIG. 8 is a flowchart of the sheet passing cleaning operation warning mode according to the present embodiment.

In the present embodiment, the threshold value Xt is set to 600 in view of the allowable amount with which toner can be held on the surface of the cleaning roller in the fixing device. The adjusted temperature Tt of the fixing device in the high gloss mode is set to 165 [° C.] and the toner remelting temperature Tn is set to 160 [° C.] similarly to the first embodiment. In view of the above, when the accumulation offset toner amount X of the print without margins is greater than the threshold value Xt and the adjusted temperature Tt in the high gloss mode in a print job is greater than the toner remelting temperature Tn, a warning process to urge the sheet passing cleaning operation is performed.

Namely, the controller 21 performs a warning process to urge the sheet passing cleaning operation before performing a high gloss mode when the offset toner amount X of print without margins performed previously to the high gloss mode exceeds the threshold value Xt by using offset toner amount X at the edge portions per a unit length in the width direction of a sheet calculated based on the surface properties, basis weight, or size information of a sheet being used.

First, in the step S201, the controller 21 acquires the print job information, the sheet information, and image information input from the operation panel portion 112.

In the step S202, the controller 21 judges whether the high gloss mode is designated or not based on the job information acquired in the step S201. When the high gloss mode is designated, the sequence proceeds to the step S203 and otherwise the sequence proceeds to the step S210.

In the step S203, the controller 21 calculates the accumulation offset toner amount X based on the sheet information and image information as stated above.

In the step S204, the controller 21 judges whether a warning to urge the sheet passing cleaning operation is necessary or not based on the accumulation offset toner amount X derived from the surface properties, basis weight and size information of a sheet and the previously set threshold value Xt. When the accumulation offset toner amount X is greater than the threshold value Xt, the sequence proceeds to the step S205 and otherwise the sequence proceeds to the step S209.

As described above, using accumulation offset toner amount as print information of print without margins, the controller 21 performs a warning process to urge the sheet passing cleaning operation before performing a high gloss mode when the accumulation offset toner amount X of print without margins performed previously to the high gloss mode exceeds the threshold value Xt.

In the step S205, the controller 21 performs a warning process to urge the sheet passing cleaning operation.

In the step S206, the controller 21 judges whether the sheet passing cleaning operation is performed or not based on the user selection information input from the operation panel portion 112. When the sheet passing cleaning operation is performed, the sequence proceeds to the step S207 and otherwise the sequence proceeds to the step S209.

In the step S207, the controller 21 performs the sheet passing cleaning operation.

In the step S208, the controller 21 clears the counter of the accumulation offset toner amount X.

In the step S209, the controller 21 performs the print process in the high gloss mode which is a high temperature operation mode.

In the step S210, the controller 21 performs the print process in the normal print mode which is a normal operation mode.

As described above, according to the present embodiment, even when a job is issued in which the adjusted temperature of the fixing device 100 becomes the adjusted temperature Tt that is higher than the toner remelting temperature Tn in the state where the offset toner amount by print without margins is large, the accumulated toner can be appropriately removed by calculating the offset toner amount X from job history and by informing a user at a more appropriate timing before the smear by the toner retransfer to a sheet becomes tangible. Namely, by performing a warning process to urge a cleaning operation for cleaning the fixing nip portion based on the accumulation offset toner amount of a print performed before the high gloss mode, the smear by toner retransfer to a sheet can be suppressed from becoming tangible.

### Third Embodiment

Next, an image forming apparatus according to the second embodiment will be described. The overall configurations of the image forming apparatus and the fixing device, a warning process, and a cleaning operation to clean a fixing nip portion are similar to those shown in FIGS. 1, 2, 6, and 7 in the first embodiment. Therefore, the same reference characters are attached to the members having the similar functions as those of the first embodiment and duplicate description will be omitted.

In the present embodiment, the smear by the toner retransfer to a sheet during a high gloss mode is suppressed in view of a size in the width direction of a sheet in case of a print without margins and a size in the width direction of a sheet during the subsequent print in a high gloss mode.

The offset toner that is attached and accumulates by a print without margins increases mainly in the position of side end of a sheet on which a print without margins has been performed in the width direction orthogonal to the sheet conveying direction. Therefore, when the size in the width direction of a sheet during a print in a subsequent job is larger than the size in the width direction of a sheet during a print without margins in a preceding job, the offset toner in the preceding job may be retransferred to the sheet in the subsequent job, causing a smear to produce.

Therefore, in the present embodiment, as print information of a print without margins, size information of a sheet being used is used. When the size W in the width direction of a sheet to be used for a print in a high gloss mode is greater than the size Wt in the width direction of a sheet having been used for a print without margins performed previously to the high gloss mode and the accumulation offset toner amount X by a print without margins exceeds the threshold value Xt, a warning screen to urge a cleaning operation is displayed and the cleaning operation is performed.

In the present embodiment, setting is made in which a print with margins is selected and 100 sheets with A3 size of OK topcoat+128 gsm (Oji Holdings Corporation), namely, with a size Wt of 297 [mm] in the width direction pass through.

In a print job in a later described image forming flow according to the present embodiment, setting is made in which a print in a high gloss mode is selected and 20 sheets with SRA3 size of OK topcoat+157 gsm (Oji Holdings Corporation) pass through. Namely, as the sheet information for a print job in a high gloss mode, a size W of 320 [mm] in the width direction is set.

### (Image Forming Flow)

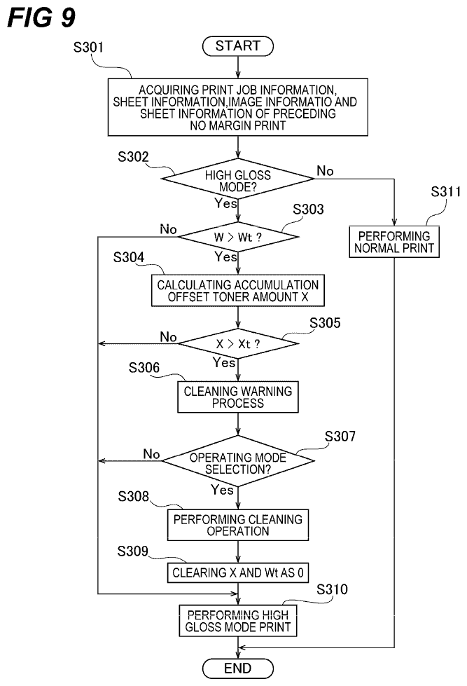

Next, a print job of an image forming flow in a print job in the present embodiment will be described. FIG. 9 is a flowchart of the sheet passing cleaning operation warning mode according to the present embodiment.

In the present embodiment, the threshold value Xt is set to 400 in view of the allowable amount with which toner can be held on the surface of the cleaning roller in the fixing device. The adjusted temperature Tt of the fixing device in the high gloss mode is set to 165 [° C.] and the toner remelting temperature Tn is set to 160 [° C.] similarly to the first embodiment. In view of the above, when the size W in the width direction of a sheet during the high gloss mode is greater than the size Wt, the accumulation offset toner amount X of the print without margins is greater than the threshold value Xt, and the adjusted temperature Tt in the high gloss mode in a print job is greater than the toner remelting temperature Tn, a warning process to urge the sheet passing cleaning operation is performed.

Namely, using a size in the width direction of a sheet being used, the controller 21 performs a warning process to urge the cleaning operation when the size W in the width direction of a sheet to be used for the high gloss mode print is greater than the size Wt in the width direction of a sheet having been used for a print without margins performed previously to the high gloss mode.

First, in the step S301, the controller 21 acquires the print job information, the sheet information, image information, and sheet information of a preceding job without margins input from the operation panel portion 112. The sheet information of a preceding job without margins is information of sizes of sheets in the width direction used so far for prints without margins.

In the step S302, the controller 21 judges whether the high gloss mode is designated or not based on the job information acquired in the step S301. When the high gloss mode is designated, the sequence proceeds to the step S303 and otherwise the sequence proceeds to the step S311.

In the step S303, the controller 21 judges whether a sheet with a width larger than the size in the width direction of a preceding sheet without margins is set or not based on job information acquired in the step S301 and the sheet information of a preceding job without margins. When the size W in the width of a sheet is greater than the size Wt, the sequence proceeds to the step S304 and otherwise the sequence proceeds to the step S310.

In the step S304, the controller 21 calculates the accumulation offset toner amount X based on the sheet information and image information as stated above.

In the step S305, the controller 21 judges whether a warning to urge the sheet passing cleaning operation is necessary or not based on the accumulation offset toner amount X derived from the surface properties, basis weight and size information of a sheet and the previously set threshold value Xt. When the accumulation offset toner amount X is greater than the threshold value Xt, the sequence proceeds to the step S306 and otherwise the sequence proceeds to the step S310.

As described above, using a size of a sheet in the width direction accumulation offset toner amount as print information of print without margins, the controller 21 performs a warning process to urge the sheet passing cleaning operation before performing a high gloss mode when the size W in the width direction of a sheet in the print without margins performed previously to the high gloss mode exceeds the size Wt, and the accumulation offset toner amount X exceeds the threshold value Xt.

In the step S306, the controller 21 performs a warning process to urge the sheet passing cleaning operation.

In the step S307, the controller 21 judges whether the sheet passing cleaning operation is performed or not based on the user selection information input from the operation panel portion 112. When the sheet passing cleaning operation is performed, the sequence proceeds to the step S308 and otherwise the sequence proceeds to the step S310.

In the step S308, the controller 21 performs the sheet passing cleaning operation.

In the step S309, the controller 21 clears the counter of the accumulation offset toner amount X and the size Wt in the width direction of as sheet as the sheet information in the preceding job without margins.

In the step S310, the controller 21 performs the print process in the high gloss mode which is a high temperature operation mode.

In the step S311, the controller 21 performs the print process in the normal print mode which is a normal operation mode.

In the present embodiment, the sheet information of a preceding job without margins and the information of accumulation offset toner amount are used. However, the disclosure is not limited to this configuration. For example, the width direction of a sheet may be divided following the size divisions and a plurality of counters for accumulation offset toner amount can be set in the respective divided regions during a print without margins.

As described above, according to the present embodiment, even when a job is issued in which the adjusted temperature of the fixing device 100 becomes the adjusted temperature Tt higher than the toner remelting temperature Tn in the state where the size in the width direction of a printing sheet in the succeeding job after performing a print without margins is larger than the size in the width direction of a sheet during a preceding print without margins and the offset toner amount by the print without margins is large, the accumulated toner can be appropriately removed by informing a user before the smear by the toner retransfer to a succeeding sheet becomes tangible. Namely, by performing a warning process to urge a cleaning operation for cleaning the fixing nip portion based on the information of a sheet being used and the accumulation offset toner amount of a print performed before the high gloss mode, the smear by toner retransfer to a sheet can be suppressed from becoming tangible.

In the above described embodiments, the information is acquired from the operation panel portion and a warning screen to urge the cleaning operation is displayed on the operation panel portion. However, the disclosure is not limited to this configuration. For example, the information may be acquired from an external device connected to the image forming apparatus wirelessly or by wire and the warning screen to urge the cleaning operation may be displayed on the external device.

In the above embodiment, four image forming portions are used. However, the number of image forming portions is not limited to four and an appropriate number can be selected as required.

In the above embodiment, a printer is exemplified as an image forming apparatus. However, the present disclosure is not limited to this configuration. The present disclosure can be applied to another image forming apparatus such as a copying machine, a facsimile apparatus, and a multi-functional machine with these functions combined. Further, the present disclosure can be applied to an image forming apparatus in which a sheet bearing member is used, and toner images of respective colors are transferred in a sequentially superimposed manner on a sheet borne on the sheet bearing member. By applying the present disclosure to these image forming apparatus, the same effect can be obtained.

According to the present disclosure, by performing a warning process to urge a cleaning operation based on the print information of a print without margins, the smear by toner retransfer to a sheet can be suppressed from becoming tangible.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-225115, filed Dec. 20, 2024, which is hereby incorporated by reference herein in its entirety.

1. An image forming apparatus comprising:
an image forming portion configured to form a toner image on a sheet;
a fixing portion configured to fix the toner image formed on the sheet at a nip portion formed between a fixing member and a pressure member;
a cleaning portion configured to collect toner attached to the fixing member;
a controller configured to control the fixing member such that the fixing member operates at a set adjusted temperature; and
a display control portion configured to display a screen at a display portion,
wherein when the controller performs an operation mode in which the controller controls the fixing member such that the fixing member operates at an adjusted temperature higher than a preset temperature, the display control portion performs a warning process to urge a cleaning operation that cleans the nip portion using a sheet passing through the nip portion based on print information of a print without margin performed before the operation mode, a toner image being formed until at least one end portion in the print without margin.

2. The image forming apparatus according to claim 1,
wherein the print information of a print without margin includes a print accumulation sheet number, and
wherein the controller performs the warning process to urge the cleaning operation before the operation mode is performed when the print accumulation sheet number N of the print without margin performed before the operation mode exceeds a threshold value Nt.

3. The image forming apparatus according to claim 1,
wherein the print information of a print without margin includes surface properties, basis weight, or size information of a sheet to be used, and
wherein the controller calculates an offset toner amount X at an edge portion per a unit length in a width direction orthogonal to a sheet conveying direction, the offset toner amount X being previously supposed according to the surface properties, basis weight, or size information of a sheet to be used, and performs the warning process to urge the cleaning operation before the operation mode is performed when the offset toner amount X of the print without margin performed before the operation mode exceeds a threshold value Xt.

4. The image forming apparatus according to claim 3,
wherein the toner amount at the edge portion of the sheet is a toner amount in an image data region corresponding to a range from an end portion of a sheet ±5 [mm] in the width direction orthogonal to the sheet conveying direction.

5. The image forming apparatus according to claim 1,
wherein the print information of a print without margin includes size information of a sheet being used, and
wherein the controller performs the warning process to urge the cleaning operation before the operation mode is performed when a size W of a sheet in a width direction orthogonal to a sheet conveying direction used in a print without margin performed before the operation mode exceeds a size Wt of a sheet in the width direction used for the print in the operation mode.

6. The image forming apparatus according to claim 1, further comprising:
an operation panel portion of a touch panel type whose input portion is disposed on the display portion in a multilayered manner,
wherein the controller displays the warning to urge the cleaning operation on the operation panel portion.

7. The image forming apparatus according to claim 1, further comprising:
an operation panel portion of a touch panel type whose input portion is disposed on the display portion in a multilayered manner,
wherein the controller displays a warning screen on the display panel portion, the warning screen including a first operational key for performing the cleaning operation and a second operational key for not performing the cleaning operation.

8. The image forming apparatus according to claim 1, further comprising:
an operation panel portion of a touch panel type whose input portion is disposed on the display portion in a multilayered manner,
wherein the controller displays a processing screen on the operation panel portion to urge to set a cleaning sheet to be used for the cleaning operation, the processing screen including an operational key for starting the cleaning operation.

9. The image forming apparatus according to claim 1,
wherein the adjusted temperature of the fixing member in the operation mode is higher than a temperature with which toner viscosity is less than or equal to 50 [Pa·s].

10. The image forming apparatus according to claim 1,
wherein the adjusted temperature of the fixing member in the operation mode is higher than a toner remelting temperature of toner collected in the cleaning portion.

11. The image forming apparatus according to claim 2,
wherein the adjusted temperature of the fixing member in the operation mode is higher than a temperature with which toner viscosity is less than or equal to 50 [Pa·s].

12. The image forming apparatus according to claim 3,
wherein the adjusted temperature of the fixing member in the operation mode is higher than a temperature with which toner viscosity is less than or equal to 50 [Pa·s].

13. The image forming apparatus according to claim 4,
wherein the adjusted temperature of the fixing member in the operation mode is higher than a temperature with which toner viscosity is less than or equal to 50 [Pa·s].

14. The image forming apparatus according to claim 5,
wherein the adjusted temperature of the fixing member in the operation mode is higher than a temperature with which toner viscosity is less than or equal to 50 [Pa·s].

15. The image forming apparatus according to claim 6,
wherein the adjusted temperature of the fixing member in the operation mode is higher than a temperature with which toner viscosity is less than or equal to 50 [Pa·s].

16. The image forming apparatus according to claim 7,
wherein the adjusted temperature of the fixing member in the operation mode is higher than a temperature with which toner viscosity is less than or equal to 50 [Pa·s].

17. The image forming apparatus according to claim 8,
wherein the adjusted temperature of the fixing member in the operation mode is higher than a temperature with which toner viscosity is less than or equal to 50 [Pa·s].

18. The image forming apparatus according to claim 2,
wherein the adjusted temperature of the fixing member in the operation mode is higher than a toner remelting temperature of toner collected in the cleaning portion.

19. The image forming apparatus according to claim 3,
wherein the adjusted temperature of the fixing member in the operation mode is higher than a toner remelting temperature of toner collected in the cleaning portion.

20. The image forming apparatus according to claim 4,
wherein the adjusted temperature of the fixing member in the operation mode is higher than a toner remelting temperature of toner collected in the cleaning portion.

21. The image forming apparatus according to claim 5,
wherein the adjusted temperature of the fixing member in the operation mode is higher than a toner remelting temperature of toner collected in the cleaning portion.

22. The image forming apparatus according to claim 6,
wherein the adjusted temperature of the fixing member in the operation mode is higher than a toner remelting temperature of toner collected in the cleaning portion.

23. The image forming apparatus according to claim 7,
wherein the adjusted temperature of the fixing member in the operation mode is higher than a toner remelting temperature of toner collected in the cleaning portion.

24. The image forming apparatus according to claim 8,
wherein the adjusted temperature of the fixing member in the operation mode is higher than a toner remelting temperature of toner collected in the cleaning portion.
